(19) United States
(12) Patent Application Publication
(10) Pub. No.: US 2020/0340839 A1
(43) Pub. Date: Oct. 29, 2020

(54) AIR FLOW RATE MEASUREMENT DEVICE

(71) Applicant: DENSO CORPORATION, Kariya-city (JP)

(72) Inventors: Junzo YAMAGUCHI, Kariya-city (JP); Noboru KlTAHARA, Kariya-city (JP)

(21) Appl. No.: 16/926,838

(22) Filed: Jul. 13, 2020

Related U.S. Application Data
(63) Continuation of application No. PCT/JP2019/001305, filed on Jan. 17, 2019.

(30) Foreign Application Priority Data
Jan. 29, 2018 (JP) 2018-012543

(51) Int. Cl. G01F 1/72; G01F 1/696; F02M 35/10

(52) U.S. Cl. CPC G01F 1/72; F02M 35/10386; G01F 1/696

(57) ABSTRACT

A processing unit processes a signal output from a sensor unit that outputs a signal corresponding to an intake air amount that is an amount of intake air flowing through an intake flow path of an internal combustion engine. The processing unit has an advance processing section and a smoothing processing section. The advance processing section performs an advance process on the signal output from the sensor unit to compensate for a response delay. The smoothing processing section performs a smoothing process on the signal processed by the advance processing section.

### CROSS REFERENCE TO RELATED APPLICATION

This application is a continuation application of International Patent Application No. PCT/JP2019/001305 filed on Jan. 17, 2019, which designated the U.S. and based on and claims the benefits of priority of Japanese Patent Application No. 2018-012543 filed on Jan. 29, 2018. The entire disclosure of all of the above applications is incorporated herein by reference.

### TECHNICAL FIELD

The present disclosure relates to an air flow rate measurement device.

### BACKGROUND

An air flow rate measurement device measures an intake air amount which is an amount of intake air flowing through an intake passage of an internal combustion engine.

### SUMMARY

An object of the present disclosure is to provide an air flow rate measurement device that measures amount of intake air with high accuracy regardless of the pulsation of intake air.

The present disclosure includes a processing unit. The processing unit processes a signal output from a sensor unit that can output a signal corresponding to an intake air amount that is an amount of intake air flowing through an intake flow path of an internal combustion engine. The processing unit has an advance processing section and a smoothing processing section. The advance processing section performs an advance process on the signal output from the sensor unit to compensate for a response delay. The smoothing processing section performs a smoothing process on the signal processed by the advance processing section.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic diagram of an engine system to which an air flow rate measurement device according to a first embodiment is applied;

FIG. 2 is a sectional view showing the air flow rate measurement device according to the first embodiment;

FIG. 3 is a block diagram showing the air flow rate measurement device according to the first embodiment;

FIG. 4 is a diagram for explaining a process in an advance processing section of the air flow rate measurement device according to the first embodiment;

FIG. 5 is a diagram for explaining a process in a conversion processing section of the air flow rate measurement device according to the first embodiment;

FIG. 6 is a diagram for explaining a process in a smoothing processing section of the air flow rate measurement device according to the first embodiment;

FIG. 7 is a diagram for explaining a process in the advance processing section, the conversion processing section, and the smoothing processing section of the air flow rate measurement device according to the first embodiment;

FIG. 8 is a diagram for explaining how to obtain a time constant used in the advance processing section of the air flow rate measurement device according to the first embodiment;

FIG. 9 is a diagram for explaining a pulsation rate of intake air used in the smoothing processing section of the air flow rate measurement device according to the first embodiment;

FIG. 10 is a diagram showing a range of a time constant used in the smoothing processing section of the air flow rate measurement device according to the first embodiment;

FIG. 11 is a block diagram showing an air flow rate measurement device according to a second embodiment;

FIG. 12 is a diagram for explaining a range of a signal processed by the advance processing section and the smoothing processing section of the air flow rate measurement device according to the second embodiment;

FIG. 13 is a block diagram showing an air flow rate measurement device according to a third embodiment;

FIG. 14 is a block diagram showing an air flow rate measurement device according to a fourth embodiment;

FIG. 15 is a block diagram showing an air flow rate measurement device according to a fifth embodiment; and

FIG. 16 is a block diagram showing an air flow rate measurement device according to a sixth embodiment.

### DETAILED DESCRIPTION

Hereinafter, air flow rate measurement devices according to a plurality of embodiments will be described with reference to the drawings. Components that are substantially the same in the plurality of embodiments are denoted by the same reference numerals and will not be described. Further, substantially identical elements in the embodiments achieve the same or similar effects.

### First Embodiment

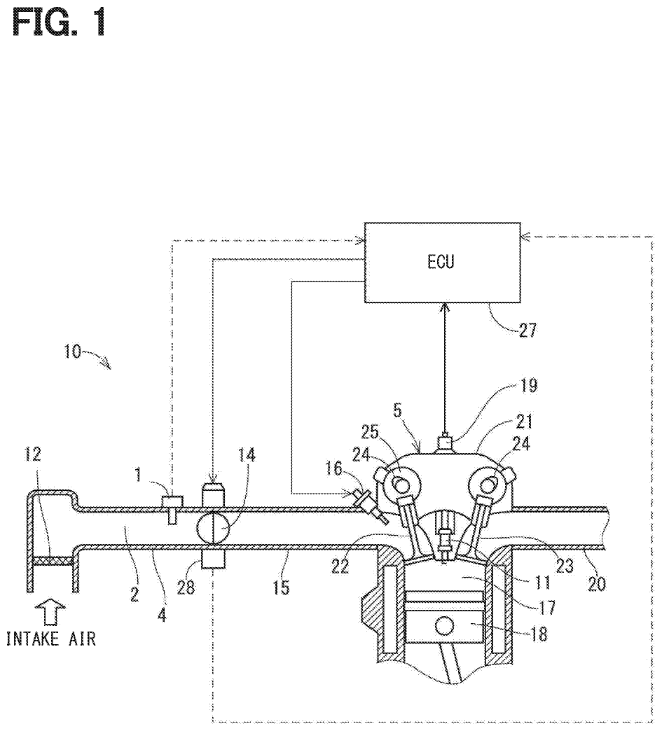

FIGS. 1 to 3 show an air flow rate measurement device according to a first embodiment. First, an engine system 10 using the air flow rate measurement device 1 will be described in FIG. 1. As shown in FIG. 1, the engine system 10 mounted on a vehicle includes a spark ignition type engine 5. The engine 5 corresponds to an internal combustion engine and is, for example, a multi-cylinder engine such as a four-cylinder engine. FIG. 1 shows only a cross section of one cylinder of the engine 5.

The engine 5 burns a mixture of intake air supplied from an intake manifold 15 via an air cleaner 12 and a throttle valve 14 and fuel injected from an injector 16 in a combustion chamber 17, and reciprocates a piston 18 due to an explosive power during combustion. A combustion gas is released into an atmosphere via an exhaust manifold 20 and the like.

An intake valve 22 is provided at an intake port of a cylinder head 21 which is an inlet of the combustion chamber 17. An exhaust valve 23 is provided at an exhaust port of the cylinder head 21 which is an outlet of the combustion chamber 17. The intake valve 22 and the exhaust valve 23 are driven to open and close by a valve drive mechanism 24. A valve timing of the intake valve 22 is adjusted by a variable valve mechanism 25.

An ignition of the air-fuel mixture in the combustion chamber 17 is performed by generating a spark discharge in the combustion chamber 17 by applying a high voltage from the ignition coil 19 to the ignition plug 11.

The vehicle includes an electronic control unit 27 (hereinafter, referred to as “ECU”). The ECU 27 is a small computer having a CPU as an arithmetic unit, a ROM, a RAM, an EEPROM as a storage unit, and an I/O as an input/output unit. The ECU 27 performs calculations in accordance with programs stored in the ROM or the like based on information such as signals from various sensors provided in various parts of the vehicle, and controls operations of various devices of the vehicle. As described above, the ECU 27 executes the program stored in the non-transitional substantial recording medium such as the ROM. When the program is executed, a method corresponding to the program is executed.

As shown by dashed arrows in FIG. 1, the ECU 27 receives signals from the air flow rate measurement device 1 and a throttle opening sensor 28. The ECU 27 calculates a combustion injection time and the like based on the signals from these sensors, and controls the operating state of the engine 5 by driving the throttle valve 14 and the injector 16 as indicated by solid arrows. As described above, the signal from the air flow rate measurement device 1 is important information for controlling the operating state of the engine system 10 with high accuracy.

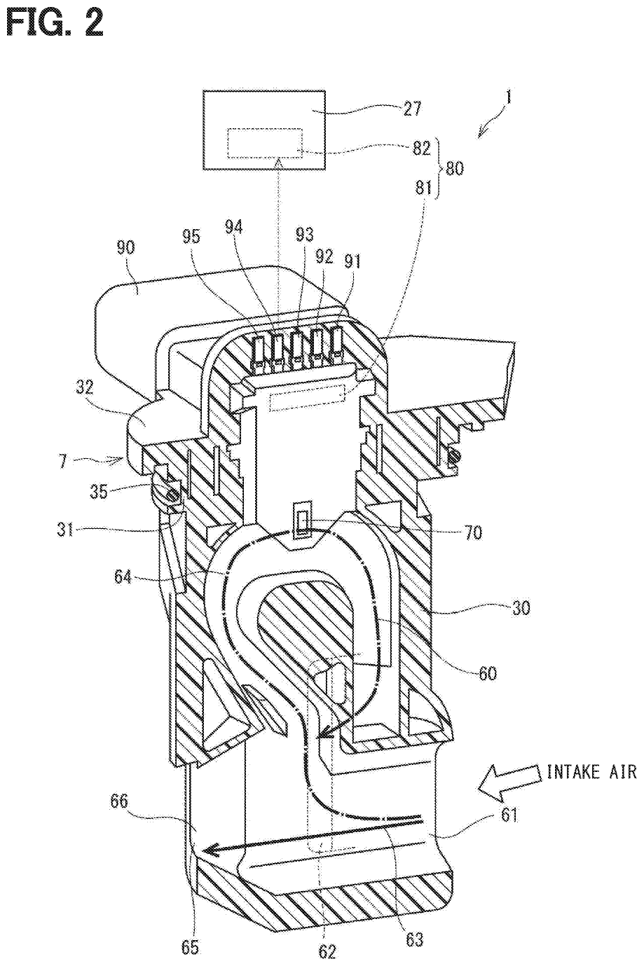

Next, the configuration of the air flow rate measurement device 1 will be described with reference to FIG. 2. The air flow rate measurement device 1 includes a housing 7, a sensor unit 70, a processing unit 80, and the like. As shown in FIG. 2, a bypass flow path 60 through which intake air can flow is formed in the bypass forming part 30 of the housing 7. The housing 7 has a sensor connector 90 formed integrally with the housing 7. The housing 7 is formed simultaneously with the sensor connector 90 during resin molding, for example. As the resin, for example, a polyester-based resin, an epoxy resin, a phenol resin, or the like is used, but is not limited to the resins.

The housing 7 includes a bypass forming part 30 which forms a bypass flow path 60 and protrudes into the intake flow path 2, a fitting part 31 that is a root of the bypass forming part 30, and an attachment part 32 to be screwed to an air duct 4 that forms the intake flow path 2.

As shown in FIG. 2, the bypass forming part 30 that forms the bypass flow path 60 has an inlet 61 of the bypass flow path 60 that opens in the intake flow path 2 toward an upstream side of the flow of the intake air. In addition, the bypass forming part 30 has an outlet 62 of the bypass flow path 60 that opens in the intake flow path 2 toward a downstream side of the flow of the intake air. Further, the bypass forming part 30 includes a straight path 63 that allows the intake air to flow straight from the inlet 61, and a circuit path 64 that circulates the intake air that flows straight through the straight path 63 along the bypass flow path 60.

As a result, a flow path length of the bypass flow path 60 is longer than a flow path length when the intake air flows straight in the straight path 63 without flowing into the bypass flow path 60. The circuit path 64 is branched into two on the downstream side, and two outlets 62 are provided. A dust discharge path 65 for discharging dust is linearly connected to the straight path 63. A lower end of the dust discharge path 65 forms a dust discharge port 66 that opens in the intake flow path 2 toward the downstream side of the flow of the intake air. The sensor unit 70 is provided so as to be exposed to the bypass flow path 60.

The bypass forming part 30 of the housing 7 extends vertically from one end surface of both surfaces in the axial direction of the fitting part 31. The bypass forming part 30 is inserted into the intake flow path 2 from an insert opening provided on a wall of the air duct 4. Thus, the sensor unit 70 is located in the intake flow path 2. That is, the housing 7 supports the sensor unit 70 so that the sensor unit 70 is located in the intake flow path 2. The bypass forming part 30 forms a core part of the housing 7, and takes in a part of the intake air flowing through the intake flow path 2 into the bypass flow path 60 to pass therethrough.

The fitting part 31 is formed in a substantially cylindrical shape, and has an annular groove on an outer peripheral surface so that an O-ring 35 is fitted into the groove. The fitting part 31 fits into the insertion opening of the wall of the air duct 4, and the O-ring 35 can keep the space between the intake flow path 2 and the outside airtight. The attachment part 32 is formed on an opposite side of the fitting part 31 with respect to the bypass forming part 30, and is thread-fastened to the air duct 4.

The sensor connector 90 has a power terminal 92, a ground terminal 93, sensor module terminals 91 and 95, a signal output terminal 94, and the like. The sensor connector 90 is formed on a side opposite to the fitting part 31 with respect to the attachment part 32. The power terminal 92, the ground terminal 93, the sensor module terminals 91 and 95, and the signal output terminal 94 are inside the sensor connector 90 and are connected to external terminals that can be connected to the outside.

The sensor unit 70 is provided in the bypass flow path 60 and can output a signal corresponding to a flow rate of the intake air by heat transfer with the intake air flowing through the bypass flow path 60. The sensor unit 70 has, for example, a heating element and a temperature sensing element formed of a thin film resistor on the surface of a semiconductor substrate. The sensor unit 70 is exposed to the bypass flow path 60 on an innermost side of the circuit path 64 and at a farthest position from the straight path 63. At the position where the sensor unit 70 is provided in the circuit path 64, the flow of the intake air is opposite to the flow in the straight path 63 and the flow in the intake flow path 2.

The power terminal 92 is connected to a power source, and the ground terminal 93 is connected to ground. Thus, the sensor unit 70 can output a signal corresponding to the intake air amount which is the flow amount of the intake air flowing through the intake flow path 2. The signal output from the sensor unit 70 is input to an internal processing unit 81 of a processing unit 80 described later, and is output to the ECU 27 via the signal output terminal 94.

The processing unit 80 includes a processing unit 81 provided inside the housing 7 and a processing unit 82 provided outside the housing 7. The processing unit 81 provided inside the housing 7 is referred to as internal processing unit 81, and the processing unit 82 provided outside the housing 7 is referred to as external processing unit 82. The internal processing unit 81 is provided, for example, in the housing 7 on the side opposite to the bypass forming part 30 with respect to the attachment part 32. The internal processing unit 81 is an electronic component such as a dedicated IC in the housing 7. The internal processing unit 81 is molded inside the housing 7. The internal processing unit 81 inputs and processes the signal output from the sensor unit 70, and outputs the processed signal to the ECU 27 via the signal output terminal 94. The external processing unit 82 is provided in the ECU 27. The external processing unit 82 is, for example, an electronic component such as the CPU in the ECU 27 or an electronic component such as a dedicated IC. The external processing unit 82 inputs and processes the signal processed by the internal processing unit 81.

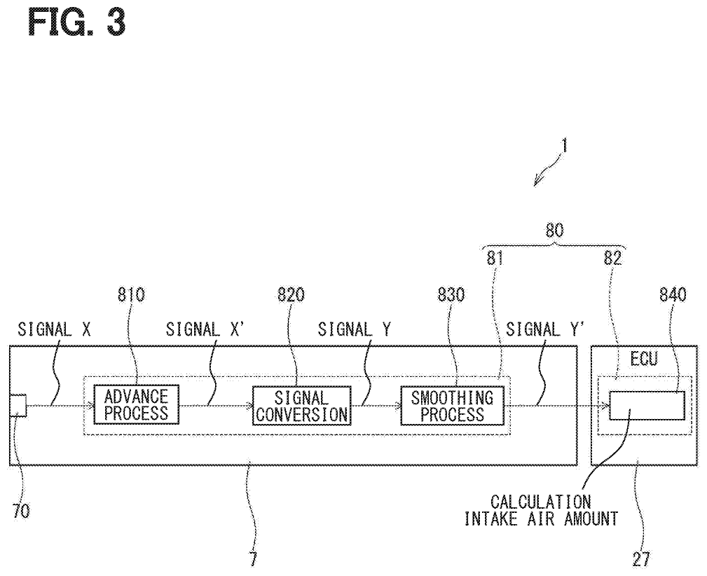

As shown in FIG. 3, in the present embodiment, the internal processing unit 81 includes an advance processing section 810, a conversion processing section 820, and a smoothing processing section 830 as conceptual functional sections. Further, the external processing unit 82 has a calculating section 840 as a conceptual functional section. The sensor unit 70 outputs a signal X corresponding to the amount of intake air flowing through the intake flow path 2, that is, the amount of intake air flowing through the bypass flow path 60, to the advance processing section 810. The advance processing section 810 processes the signal X output from the sensor unit 70 and outputs the processed signal X′ to the conversion processing section 820. The conversion processing section 820 processes signal X′ output from the advance processing section 810 and outputs processed signal Y to the smoothing processing section 830. The smoothing processing section 830 processes the signal Y output from the conversion processing section 820, and outputs the processed signal Y′ to the calculating section 840. The calculating section 840 calculates, that is, measures the intake air amount, which is the amount of intake air flowing through the intake flow path 2, based on the signal Y′ output from the smoothing processing section 830.

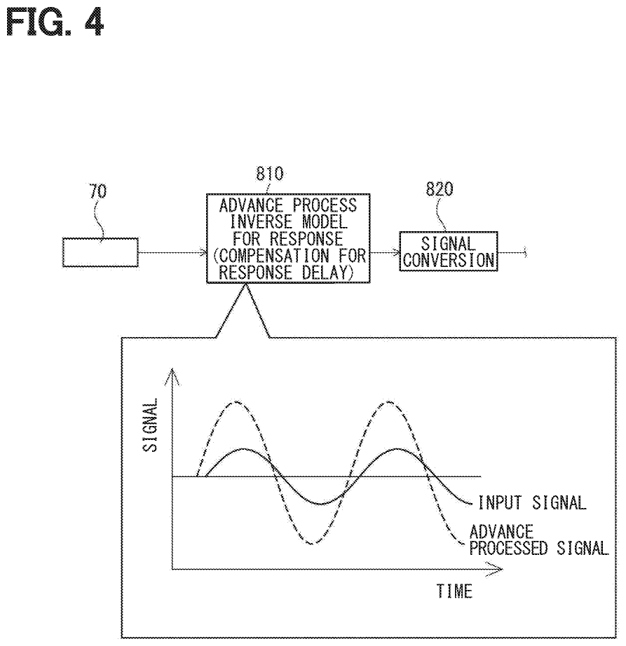

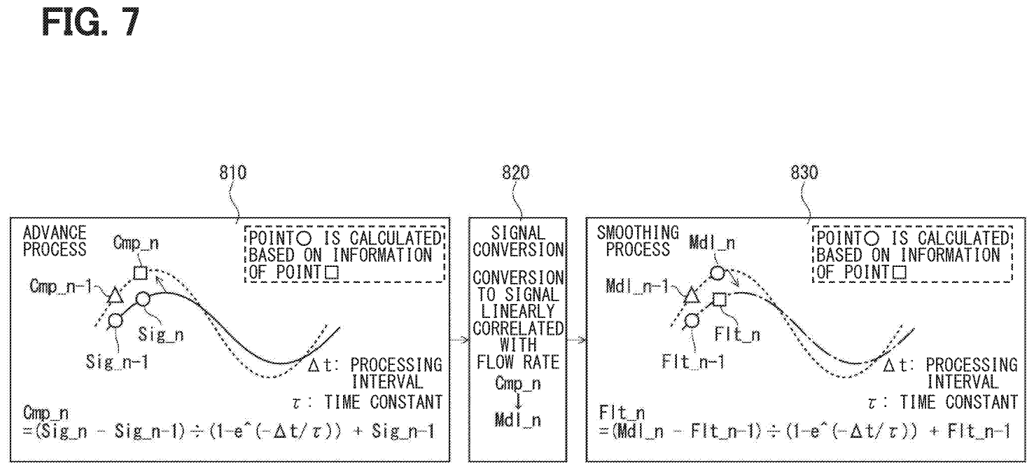

Next, a specific process in each processing section will be described. As shown in FIG. 4, the advance processing section 810 performs advance processing for compensating for a response delay with respect to the input signal (solid line), which is a signal input from the sensor unit 70, and outputs the processed signal to the conversion processing section 820 as an advance processed signal (broken line). Specifically, as shown in FIG. 7, the advance processing section 810 performs the advance process based on an inverse model that is a primary delay equation represented by a following Equation 1, that is, an inverse operation of the primary delay (Equation 2).

Sig_n=(Cmp_n-Sig_n−1)×(1−e\hat{ }(−Δt/τ))+Sig_n−1 Equation 1

Cmp_n=(Sig_n−Sig_n−1)÷(1−e\hat{ }(−Δt/τ))+Sig_ₙ−1 Equation 2

In Equations 1 and 2, Sig_n represents the current value of the input signal, Sig_n−1 represents the previous value of the input signal, and Cmp_n represents the current value of the advance processed signal. Further, e represents the base of the natural logarithm (Napier number), \hat{ } represents a power, Δt represents a processing interval (calculation interval) in the advance processing section 810, and T represents a time constant. As shown in FIG. 7, the process (formula 2) performed by the advance processing section 810 is a process of calculating a point of Cmp_n of the advance processed signal based on the information of the Sig_n point of the input signal and the information of the point of Sig_n−1.

In the present embodiment, the time constant τ used in the process (Equation 2) performed by the advance processing section 810 is changed according to the flow rate (G) that is the speed of the intake air flowing through the intake flow path 2. Specifically, the time constant τ is changed based on the following equation 3 or 4.

τ=a×G+b Equation 3

τ=a×log(G)+b Equation 4

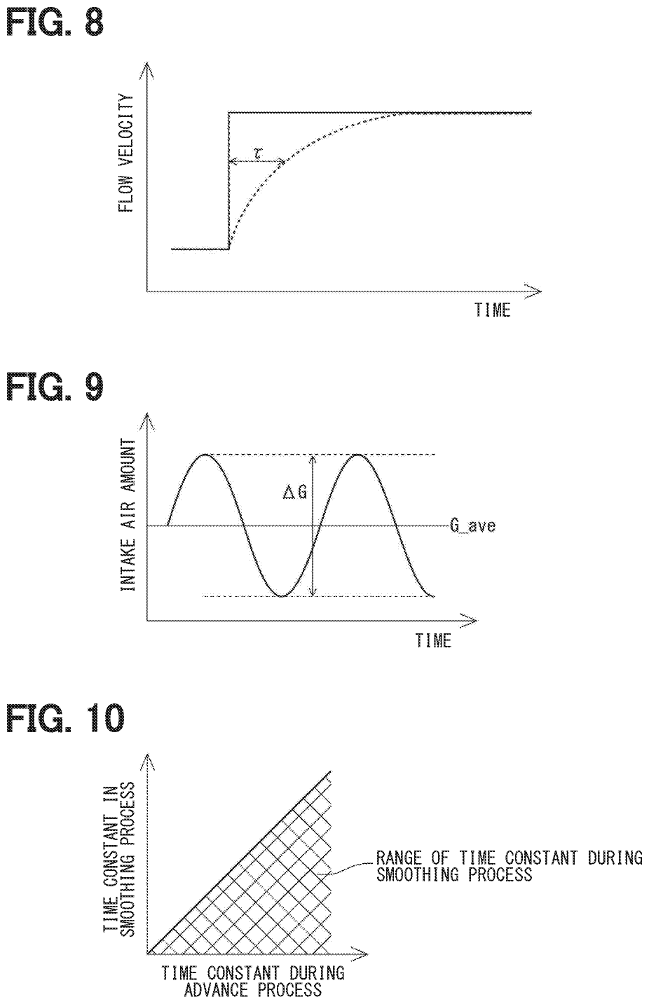

In Equations 3 and 4, a>0 and b≥0. The time constant τ is directly proportional to the flow rate (G). The actual time constant τ is calculated experimentally. Specifically, as shown in FIG. 8, a flow velocity (flow rate) is measured by both a very high response flow rate measurement device and an air flow rate measurement device (air flow meter). For example, the flow velocity is measured while changing stepwise from a low flow velocity to a high flow velocity, and the time constant τ is obtained based on the measurement result. In FIG. 8, the solid line shows the measurement result performed by the air flow rate measurement device with high response, and the broken line shows the measurement result performed by the air flow meter.

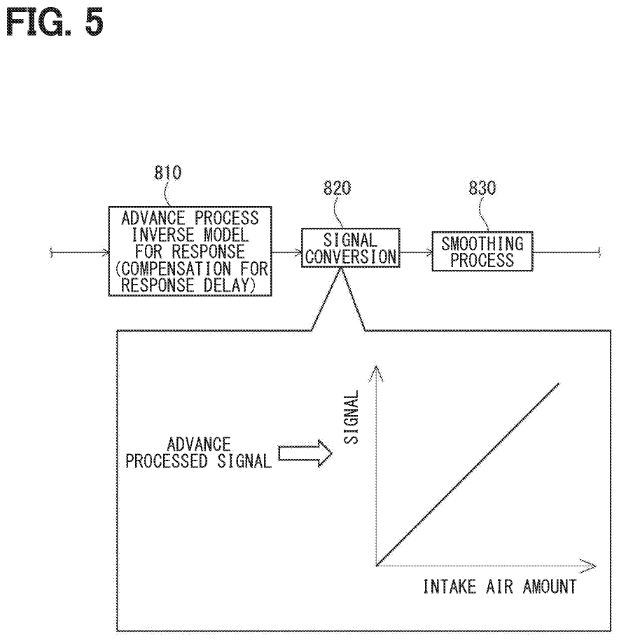

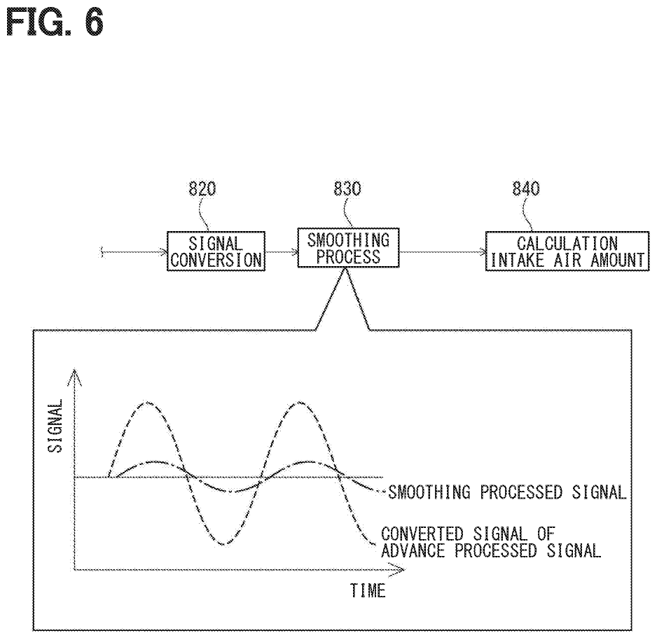

As shown in FIG. 5, the conversion processing section 820 converts the advance processed signal, which is the signal input from the advance processing section 810, into a signal having a linear correlation with the flow rate, and outputs the converted signal to the smoothing processing section 830 as a converted signal (broken line) (see FIG. 6). Specifically, as shown in FIG. 7, the conversion processing section 820 converts the current value Cmp_n of the advance processed signal into a signal Mdl_n having a linear correlation with the flow rate.

As shown in FIG. 6, the smoothing processing section 830 performs a smoothing process in which the converted signal (broken line), which is the signal input from the conversion processing section 820 and converted from the advance processed signal is smoothed. The smoothing processing section 830 outputs the processed signal to the calculating section 840 as a smoothing processed signal (dashed line). Specifically, as shown in FIG. 7, the smoothing processing section 830 performs the smoothing process based on Expression 5 below.

Flt_n=(Mdl_n−Flt_n−1)÷(1−e\hat{ }(−Δt/τ))+Flt_n−1 Expression 5

In the above equation 5, Mdl_n represents the current value of the converted signal converted from the advance processed signal, Flt_n−1 represents the previous value of the smoothing processed signal, and Flt_n represents the current value of the smoothing processed signal. Δt represents a processing interval in the smoothing processing section 830, and T represents a time constant. As shown in FIG. 7, the process (Equation 5) performed by the smoothing processing section 830 is a process of calculating a point of Flt_n of the smoothing processed signal based on the information of a point of Mdl_n of the converted signal converted from the advance processed signal and a point of Flt_n−1 of the smoothing processed signal.

In the present embodiment, Mdl_n, which is a value for performing the smoothing process (Equation 5), that is, Sig_n−1 and Sig_n include a pulsation rate of intake air, a pulsation frequency that is a frequency when intake air pulsates, and Information on the average flow rate of intake air. That is, the smoothing processing section 830 forms a signal that has been processed by the advance processing section 810 based on the pulsation rate of intake air, the pulsation frequency of intake air, and the average flow rate of intake air. Here, the pulsation rate A of the intake air is represented by the following equation 6.

A=ΔG/2/G_ave Equation 6

In the above equation 6, ΔG represents the total amplitude of the intake flow rate, and G_ave represents the average intake flow rate (see FIG. 9). That is, the pulsation rate A is a value obtained by dividing the value (ΔG/2) obtained by halving the amplitude of the flow rate of the intake air by the average flow rate (G_ave) of the intake air.

In the present embodiment, the smoothing processing section 830 performs a smoothing of the converted signal converted from the advance processed signal using a time constant τ that is equal to or less than the time constant τ used when performing the advance process (Equation 2) in the advance processing section 810. (Equation 5). That is, the time constant τ used in the smoothing process (Equation 5) performed by the smoothing processing section 830 is a value included in the shaded range shown in FIG. 10.

The calculating section 840 calculates, that is, measures an intake air amount which is an amount of the intake air flowing through the intake flow path 2 based on the signal (Flt_n) which has been subjected to the smoothing process and is a signal input from the smoothing processing section 830, for example, by using conversion map representing a conversion range between the signal and the flow rate.

As described above, the present embodiment includes the processing unit 80. The processing unit 80 processes the signal output from the sensor unit 70 that can output a signal corresponding to the intake air amount that is the amount of intake air flowing through the intake flow path 2 of the engine 5. The processing unit 80 includes the advance processing section 810 and a smoothing processing section 830. The advance processing section 810 performs the advance process on the signal output by the sensor unit 70 to compensate for a response delay. The smoothing processing section 830 performs the smoothing process on the signal processed by the advance processing section 810.

In the present embodiment, the advance processing section 810 compensates for the response delay with respect to the signal output from the sensor unit 70, so that the difference between the calculated or measured intake air amount and the actual intake air amount can be reduced. In addition, since the smoothing processing section 830 smooths the signal after being processed by the advance processing section 810, even if the pulsation of the intake air is large and the signal input from the sensor unit 70 to the advance processing section 810 has a high amplitude, the signal output from the smoothing processing section 830 can be within a range in which the amount of intake air can be calculated. Therefore, regardless of the pulsation of the intake air, the intake air amount can be measured with high accuracy.

In the present embodiment, the processing unit 80 further includes a conversion processing section 820. The conversion processing section 820 converts the signal processed by the advance processing section 810 into the signal having a linear correlation with the flow rate, and outputs the signal to the smoothing processing section 830. By the way, when the signal input to the smoothing processing section 830 and the flow rate have a non-linear relationship, the signal performed by the smoothing process may be distorted. In the present embodiment, as described above, the conversion processing section 820 converts the signal processed by the advance processing section 810 into the signal having a linear correlation with the flow rate, and outputs the signal to the smoothing processing section 830. Thereby, distortion of the smoothing processed signal processed by the smoothing process in the smoothing processing section 830 can be suppressed. Therefore, the intake air amount can be measured with higher accuracy.

In the present embodiment, the advance processing section 810 compensates for the response delay on the signal output from the sensor unit 70 by performing the inverse operation of the primary delay. Accordingly, the advance processing section 810 can perform the advance process with relatively simple calculations. Therefore, the circuit configuration of the advance processing section 810 can be simplified.

In the present embodiment, the advance processing section 810 changes the time constant used when performing the inverse operation of the primary delay on the signal output from the sensor unit 70 in accordance with the flow rate that is the speed of the intake air flowing through the intake flow path 2. In general, as the flow rate of the intake air increases, the response during pulsation becomes higher and the time constant becomes smaller. In the present embodiment, as described above, the advance processing section 810 changes the time constant used when performing the inverse operation of the primary delay according to the flow rate. Therefore, the intake air amount can be measured with higher accuracy.

Further, in the present embodiment, the smoothing processing section 830 performs the smoothing process on the signal after being processed by the advance processing section 810 based on the pulsation rate of the intake air, the pulsation frequency that is the frequency when the intake air pulsates, and the average flow rate of the intake air. As described above, since the smoothing processing section 830 performs the smoothing process based on the state of the intake air, the signal output from the smoothing processing section 830 can be appropriately maintained within the range in which the intake air amount can be calculated.

Further, in the present embodiment, the smoothing processing section 830 uses the time constant equal to or less than the time constant used when performing the advance process in the advance processing section 810, and smooths the signal processed by the advance processing section 810. Thereby, the signal output from the smoothing processing section 830 can be more appropriately maintained within the range in which the intake air amount can be calculated.

In addition, the present embodiment further includes the sensor unit 70 and the housing 7. The housing 7 supports the sensor unit 70 so that the sensor unit 70 is located in the intake flow path 2. The processing unit 80 includes the internal processing unit 81 provided inside the housing 7 and the external processing unit 82 provided outside the housing 7. As described above, in the present embodiment, the sensor unit 70 and the internal processing unit 81 which is a part of the processing unit 80 are integrated into a module.

In the present embodiment, the internal processing unit 81 includes the advance processing section 810 and the smoothing processing section 830. In the present embodiment, the advance processing section 810, the conversion processing section 820, and the smoothing processing section 830 are disposed in the internal processing unit 81 provided in the housing 7, and the calculating section 840 is disposed in the external processing unit 82 provided in the ECU 27 which is located at a position other than the housing 7. As described above, the process up to performing the smoothing process on the signal output from the sensor unit 70 is performed on the housing 7 side, and the process for calculating the intake air amount is performed on the ECU 27 side. The section where each process is executed is specified. With this configuration, in the process of the processing unit 80, the load of the process on the ECU 27 side can be reduced.

### Second Embodiment

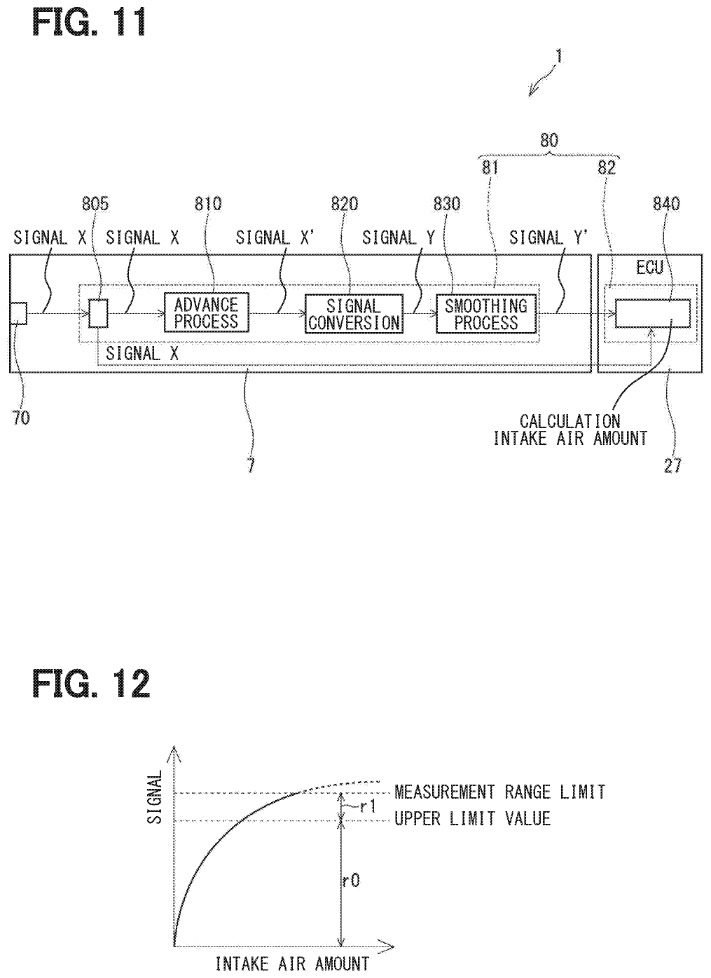

FIG. 11 shows an air flow rate measurement device according to a second embodiment. The second embodiment differs from the first embodiment in the configuration and the like of the processing unit 80.

In the present embodiment, the processing unit 80 further includes a determination section 805. The determination section 805 is included in the internal processing unit 81 provided in the housing 7. The determination section 805 determines whether the signal X output from the sensor unit 70 has exceeded a predetermined upper limit value within the measurement range, and determines whether the signal X is output to the advance processing section 810 or the calculating section 840.

As shown in FIG. 12, when the signal X output from the sensor unit 70 has a value in a range r1 exceeding the predetermined upper limit value within the measurement range, the determination section 805 determines that the signal X exceeds the predetermined upper limit value within the measurement range, and outputs the signal X to the advance processing section 810. After the above processing, in the same manner as in the first embodiment, the signal processing is performed in the advance processing section 810, the conversion processing section 820, and the smoothing processing section 830. The intake air amount is calculated or measured in the calculating section 840 based on the signal Y′ output from the smoothing processing section 830 (see FIG. 11).

On the other hand, when the signal X output from the sensor unit 70 has a value in the range r0 that is equal to or less than the predetermined upper limit value in the measurement range, the determination section 805 determines that the signal X does not exceed the predetermined upper limit value in the measurement range, and outputs the signal X to the calculating section 840. After the above processing, the calculating section 840 calculates or measures the intake air amount based on the signal X (see FIG. 11).

As described above, the processing unit 80 executes the processing by the advance processing section 810, the conversion processing section 820, and the smoothing processing section 830 only when the signal X output from the sensor unit 70 exceeds the predetermined upper limit value within the measurement range. If the signal X does not exceed the predetermined upper limit value within the measurement range, the processing unit 80 does not execute the processing by the advance processing section 810, the conversion processing section 820, and the smoothing processing section 830, and calculates the intake air amount based on the signal X in the calculating section 840.

As described above, in the present embodiment, the processing unit 80 executes the processing by the advance processing section 810 and the smoothing processing section 830 only when the signal output from the sensor unit 70 exceeds a predetermined upper limit value. That is, the processing unit 80 performs the processing by the advance processing section 810 and the smoothing processing section 830 only when the signal output from the sensor unit 70 may exceed the range in which the calculating section 840 can calculate the intake air amount. In other case, the processing unit 80 does not execute the processing by the advance processing section 810 and the smoothing processing section 830. Thereby, the processing load on the processing unit 80 can be reduced according to the situation.

### Third Embodiment

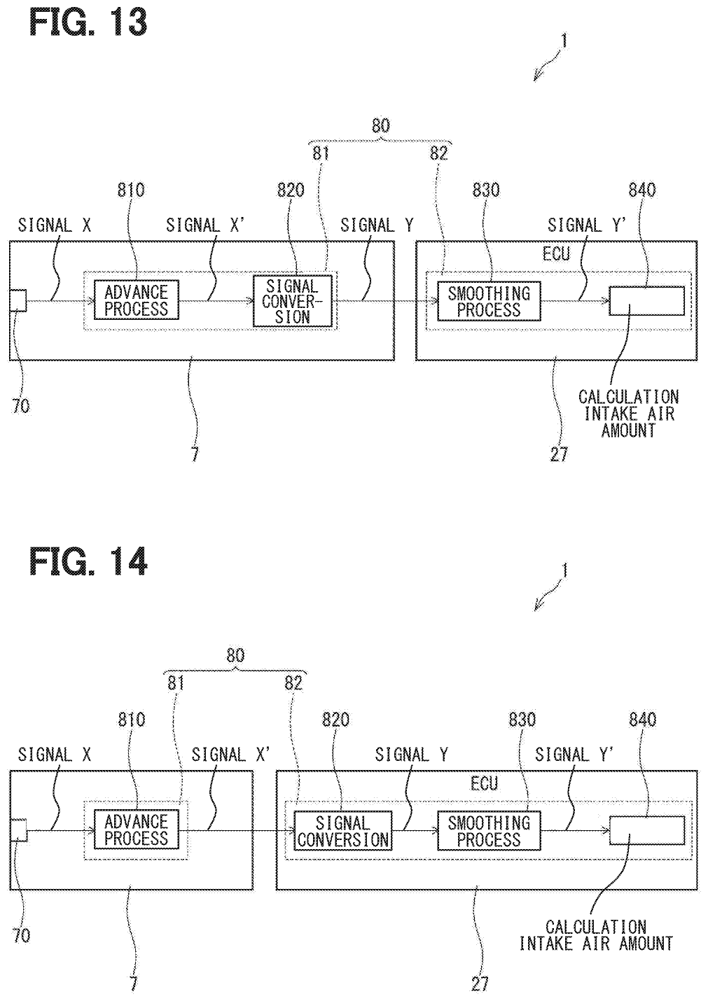

FIG. 13 shows an air flow rate measurement device according to a third embodiment. The third embodiment differs from the first embodiment in the configuration and the like of the processing unit 80.

In the present embodiment, the internal processing unit 81 provided in the housing 7 includes the advance processing section 810 and the conversion processing section 820. On the other hand, the external processing unit 82 provided in the ECU 27 includes the smoothing processing section 830 and the calculating section 840. In the present embodiment, the signal X output from the sensor unit 70 is processed in the same manner as in the first embodiment in the advance processing section 810 and the conversion processing section 820 of the internal processing unit 81. The signal Y output from the conversion processing section 820 is processed in the smoothing processing section 830 of the external processing unit 82 by the same processing as in the first embodiment. Then, the calculating section 840 calculates or measures the intake air amount based on the signal Y′ output from the smoothing processing section 830 (see FIG. 13).

As described above, in the present embodiment, the internal processing unit 81 includes the advance processing section 810. The external processing unit 82 includes the smoothing processing section 830. In the present embodiment, the advance processing section 810 and the conversion processing section 820 are disposed in the internal processing unit 81 provided in the housing 7, and the smoothing processing section 830 and the calculating section 840 is disposed in the external processing unit 82 provided in the ECU 27 which is located at a position other than the housing 7. As described above, the process up to performing the conversion process on the signal output from the sensor unit 70 is performed on the housing 7 side, and the processes for smoothing the signal and for calculating the intake air amount are performed on the ECU 27 side. The section where each process is executed is specified. With this configuration, the processing of the processing unit 80 can be shared between the housing 7 side and the ECU 27 side in a well-balanced manner.

### Fourth Embodiment

FIG. 14 shows an air flow rate measurement device according to a fourth embodiment. The fourth embodiment differs from the first embodiment in the configuration and the like of the processing unit 80.

In the present embodiment, the internal processing unit 81 provided in the housing 7 includes the advance processing section 810. On the other hand, the external processing unit 82 provided in the ECU 27 includes the conversion processing section 820, the smoothing processing section 830, and the calculating section 840. In the present embodiment, the signal X output from the sensor unit 70 is processed in the same manner as in the first embodiment in the advance processing section 810 of the internal processing unit 81. The signal X′ output from the advance processing section 810 is processed in the conversion processing section 820 and the smoothing processing section 830 of the external processing unit 82 by the same processing as in the first embodiment. Then, the calculating section 840 calculates or measures the intake air amount based on the signal Y′ output from the smoothing processing section 830 (see FIG. 14).

As described above, in the present embodiment, the internal processing unit 81 includes the advance processing section 810. The external processing unit 82 includes the smoothing processing section 830. In the present embodiment, the advance processing section 810 is disposed in the internal processing unit 81 provided in the housing 7, and the conversion processing section 820, the smoothing processing section 830, and the calculating section 840 are disposed in the external processing unit 82 provided in the ECU 27 which is located at a position other than the housing 7. As described above, the process up to performing the advance process on the signal output from the sensor unit 70 is performed on the housing 7 side, and the signal conversion process, the smoothing process, and the calculation of the intake air amount are performed on the ECU 27 side. The section where each process is executed is specified. With this configuration, the processing of the processing unit 80 can be shared between the housing 7 side and the ECU 27 side in a well-balanced manner.

### Fifth Embodiment

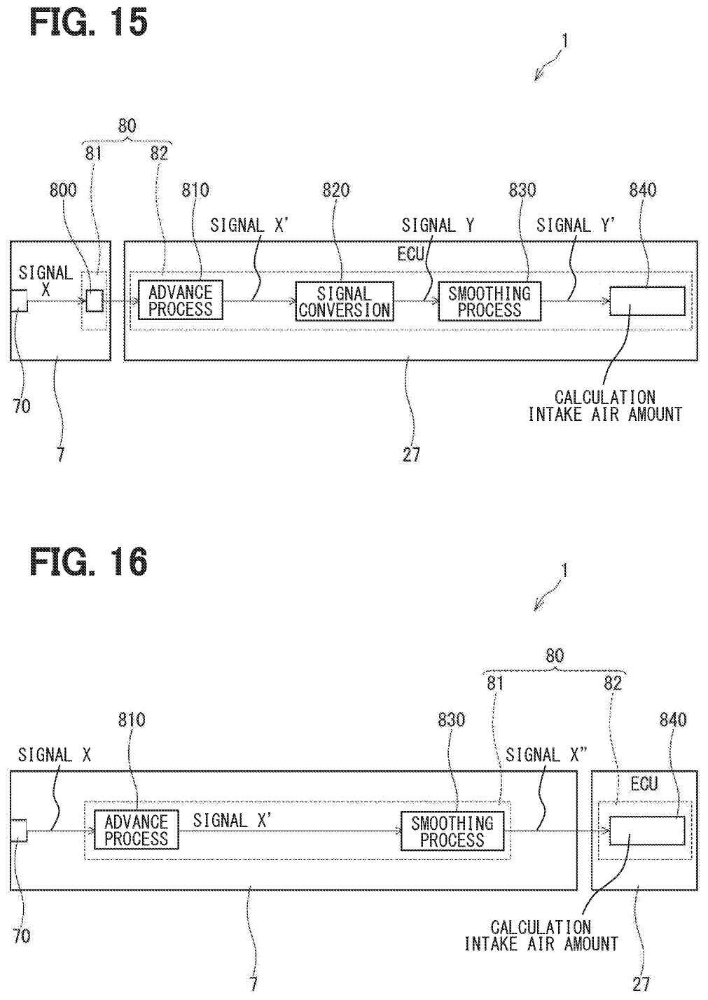

FIG. 15 shows an air flow rate measurement device according to a fifth embodiment. The fifth embodiment differs from the first embodiment in the configuration and the like of the processing unit 80.

In the present embodiment, the processing unit 80 further includes an output section 800. The output section 800 is included in the internal processing unit 81 provided in the housing 7. The external processing unit 82 provided in the ECU 27 includes the advance processing section 810, the conversion processing section 820, the smoothing processing section 830, and the calculating section 840. The output section 800 outputs the signal X output from the sensor unit 70 to the advance processing section 810 of the external processing unit 82 as it is.

As shown in FIG. 15, the signal X output from the sensor unit 70 proceeds as it is by the output section 800 and is output to the advance processing section 810. After the above processing, in the same manner as in the first embodiment, the signal processing is performed in the advance processing section 810, the conversion processing section 820, and the smoothing processing section 830. The intake air amount is calculated or measured in the calculating section 840 based on the signal Y′ output from the smoothing processing section 830 (see FIG. 15).

As described above, in the present embodiment, the external processing unit 82 includes the advance processing section 810 and the smoothing processing section 830. In the present embodiment, the output section 800 is disposed in the internal processing unit 81 provided in the housing 7, and the advance processing section 810, the conversion processing section 820, the smoothing processing section 830, and the calculating section 840 are disposed in the external processing unit 82 provided in the ECU 27 which is located at a position other than the housing 7. As described above, the process up to performing the output process on the signal output from the sensor unit 70 is performed on the housing 7 side, and the advance process, the signal conversion process, the smoothing process, and the calculation of the intake air amount are performed on the ECU 27 side. The section where each process is executed is specified. With this configuration, in the process of the processing unit 80, the load of the process on the housing 7 side can be reduced.

### Sixth Embodiment

FIG. 16 shows an air flow rate measurement device according to a sixth embodiment. The sixth embodiment differs from the first embodiment in the configuration and the like of the processing unit 80.

In the present embodiment, the processing unit 80 does not include the conversion processing section 820 shown in the first embodiment. In the present embodiment, the signal X′ output from the advance processing section 810 is subjected to the smoothing process in the smoothing processing section 830 by the same method as in the first embodiment. The signal X “subjected to the smoothing process in the smoothing processing section 830 is output to the calculating section 840. Then, the calculating section 840 calculates or measures the intake air amount based on the signal X” output from the smoothing processing section 830 (see FIG. 16).

As described above, in the present embodiment, the processing unit 80 does not include the conversion processing section 820. However, in the present embodiment, since the processing unit 80 includes the advance processing section 810 and the smoothing processing section 830, the same effect as in the first embodiment can be obtained.

### OTHER EMBODIMENTS

In the above-described second to fifth embodiments, the example in which the processing unit 80 includes the conversion processing section 820 has been described. In contrast, in another embodiment of the present disclosure, in each of the above embodiments, the processing unit 80 may not include the conversion processing section 820 as in the sixth embodiment.

In the present embodiment, the advance processing section 810 compensates for the response delay on the signal output from the sensor unit 70 by performing the inverse operation of the primary delay. In contrast, in another embodiment of the present disclosure, the advance processing section 810 may compensate for the response delay of the signal output from the sensor unit 70 by a method other than the inverse operation of the primary delay.

In the present embodiment, the advance processing section 810 changes the time constant used when performing the inverse operation of the primary delay on the signal output from the sensor unit 70 in accordance with the flow rate that is the speed of the intake air flowing through the intake flow path 2. In contrast, in another embodiment of the present disclosure, the advance processing section 810 sets the time constant used when performing the inverse operation of the primary delay on the signal output from the sensor unit 70 to a predetermined value.

Further, in the present embodiment, the smoothing processing section 830 performs the smoothing process on the signal after being processed by the advance processing section 810 based on the pulsation rate of the intake air, the pulsation frequency that is the frequency when the intake air pulsates, and the average flow rate of the intake air. In contrast, in another embodiment of the present disclosure, the smoothing processing section 830 performs the smoothing process on the signal after being processed by the advance processing section 810 based on the pulsation rate of the intake air, the pulsation frequency that is the frequency at which the intake air pulsates, and the average flow rate of the intake air. That is, the signal output from the sensor unit 70 may not include all the information of the pulsation rate of the intake air, the pulsation frequency of the intake air, and the average flow rate of the intake air. In another embodiment of the present disclosure, the smoothing processing section 830 may smooth the signal processed by the advance processing section 810 without being based on any of the pulsation rate of the intake air, the pulsation frequency of the intake air, and the average flow rate of the intake air.

Further, in the present embodiment, the smoothing processing section 830 uses the time constant equal to or less than the time constant used when performing the advance process in the advance processing section 810, and smooths the signal processed by the advance processing section 810. In contrast, in another embodiment of the present disclosure, the smoothing processing section 830 may smooth the signal after processing by the advance processing section 810 using a time constant larger than the time constant used when performing the advance processing in the advance processing section 810. Further, in another embodiment of the present disclosure, the smoothing processing section 830 may smooth the signal by using any processing if the amplitude of the signal after processing is smaller than the amplitude of the signal before processing, for example.

In the above-described embodiment, the calculating section 840 is included in the external processing unit 82. In contrast, in another embodiment of the present disclosure, the calculating section 840 may be included in the internal processing unit 81 instead of in the external processing unit 82. In this case, the calculation, that is, the measurement of the intake air amount is performed on the housing 7 side.

In the above-described fifth embodiment, the internal processing unit 81 includes the output section 800. On the other hand, in another embodiment of the present disclosure, the internal processing unit 81 does not include the output section 800, and the sensor unit 70 may output the signal as it is to the advance processing section 810 of the external processing unit 82.

Further, in the above-described embodiment, the output section 800, the determination section 805, the advance processing section 810, the conversion processing section 820, the smoothing processing section 830, and the calculating section 840, which are the respective functional sections of the processing unit 80, are implemented by software such as a program. On the other hand, in another embodiment of the present disclosure, at least one of the functional sections of the processing unit 80 may be realized by hardware using a dedicated circuit or the like.

Thus, the present disclosure is not limited to the above embodiments but can be implemented in various forms without departing from the scope thereof.

The present disclosure has been described based on the embodiments. However, the present disclosure is not limited to the embodiments and structures. This disclosure also encompasses various modifications and variations within the scope of equivalents. Furthermore, various combination and formation, and other combination and formation including one, more than one or less than one element may be made in the present disclosure.

In an assumable example, an air flow rate measurement device measures an intake air amount which is an amount of intake air flowing through an intake passage of an internal combustion engine. For example, an air flow rate measurement device performs an advance process for compensating for a response delay with respect to a signal output from a sensor unit that outputs a signal corresponding to the intake air amount, and measures the intake air amount based on the signal. Thereby, the air flow rate measurement device reduces a difference between a measured intake air amount and an actual intake air amount.

In the air flow rate measurement device, when a signal with the response delay compensation is converted into a flow rate, a signal whose amplitude of a pulsation signal is amplified is converted into a flow rate. However, in practice, a conversion maps for performing a conversion between the signal and the flow rate are limited. Therefore, when a pulsation signal having a higher amplitude is input, the pulsation signal may exceed a convertible range, and there is a possibility that the signal may not be converted to the flow rate.

An object of the present disclosure is to provide an air flow rate measurement device that measures the amount of intake air with high accuracy regardless of the pulsation of intake air.

The present disclosure includes a processing unit. The processing unit processes a signal output from a sensor unit that can output a signal corresponding to an intake air amount that is an amount of intake air flowing through an intake flow path of an internal combustion engine. The processing unit has an advance processing section and a smoothing processing section. The advance processing section performs an advance process on the signal output by the sensor unit to compensate for a response delay. The smoothing processing section performs a smoothing process on the signal processed by the advance processing section.

In the present embodiment, the advance processing section compensates for the response delay with respect to the signal output from the sensor unit, so that the difference between the calculated intake air amount and the actual intake air amount can be reduced. In addition, since the smoothing processing section smooths the signal after being processed by the advance processing section, even if the pulsation of the intake air is large and the signal input from the sensor unit to the advance processing section has a high amplitude, the signal output from the smoothing processing section can be maintained within a range in which the amount of intake air can be calculated. Therefore, regardless of the pulsation of the intake air, the intake air amount can be measured with high accuracy.

1. An air flow rate measurement device comprising:
a processing unit configured to process a signal output from a sensor unit that outputs a signal corresponding to an intake air amount that is an amount of intake air flowing through an intake flow path of an internal combustion engine, wherein
the processing unit includes
an advance processing section configured to perform an advance process on the signal output from the sensor unit to compensate for a response delay, and
a smoothing processing section configured to perform a smoothing process on the signal processed by the advance processing section.

2. The air flow rate measurement device according to claim 1, wherein
the processing unit includes
a conversion processing section configured to convert the signal processed by the advance processing section into a signal having a linear correlation with the flow rate, and configured to output the signal to the smoothing processing section.

3. The air flow rate measurement device according to claim 1, wherein
the advance processing section compensates for the response delay by performing an inverse operation of a primary delay on the signal output from the sensor unit.

4. The air flow rate measurement device according to claim 3, wherein
the advance processing section changes a time constant used when performing the inverse operation of the primary delay on the signal output from the sensor unit in accordance with the flow rate that is the speed of the intake air flowing through the intake flow path.

5. The air flow rate measurement device according to claim 1, wherein
the smoothing processing section performs the smoothing process on the signal after being processed by the advance processing section based on at least one of a pulsation rate of the intake air, a pulsation frequency that is a frequency when the intake air pulsates, and an average flow rate of the intake air.

6. The air flow rate measurement device according to claim 1, wherein
the smoothing processing section uses a time constant equal to or less than the time constant used when performing the advance process in the advance processing section, and smooths the signal processed by the advance processing section.

7. The air flow rate measurement device according to claim 1, wherein
the processing unit executes processing by the advance processing section and the smoothing processing section only when the signal output by the sensor unit exceeds a predetermined upper limit.

8. The air flow rate measurement device according to claim 1, further comprising,
the sensor unit, and
a housing that supports the sensor unit such that the sensor unit is located in the intake flow path, wherein
the processing unit includes an internal processing unit provided in the housing, and an external processing unit provided in a position other than the housing.

9. The air flow rate measurement device according to claim 8, wherein
the internal processing unit includes the advance processing section and the annealing processing section.

10. The air flow rate measurement device according to claim 8, wherein
the internal unit includes the advance processing section, and
the external processing unit includes the smoothing processing section.

11. The air flow rate measurement device according to claim 8, wherein
the external processing unit includes the advance processing section and the smoothing processing section.

12. An air flow rate measurement device for measuring an intake air amount that is an amount of intake air following through an intake flow path of an internal combustion engine, the air flow rate measurement device comprising:
an advance processing section configured to perform an advance process on a signal output from a sensor unit that outputs a signal corresponding to the intake air amount to compensate for a response delay;
a smoothing processing section configured to perform a smoothing process on the signal processed by the advance processing section; and
a calculating section configured to calculate the intake air amount based on the signal output from the smoothing processing section.
